(19) United States
(12) Patent Application Publication
(10) Pub. No.: US 2013/0013776 A1
(43) Pub. Date: Jan. 10, 2013

(54) INFORMATION PROCESSING DEVICE, INFORMATION PROCESSING SYSTEM, INFORMATION PROCESSING METHOD, AND INFORMATION STORAGE MEDIUM

(75) Inventor: Shoji Tajima, Tokyo (JP)

(73) Assignee: NEC CORPORATION, Tokyo (JP)

(21) Appl. No.: 13/635,861

(22) PCT Filed: Feb. 24, 2011
(86) PCT No.: PCT/JP2011/001073

§ 371 Date: Sep. 18, 2012

(30) Foreign Application Priority Data
Mar. 19, 2010 (JP) 2010-064005

(51) Int. Cl. G06F 15/173

(52) U.S. Cl. 709/224

(57) ABSTRACT

Disclosed is an information processing device which detects a difference in environment so as to make a change to an information collection function, thereby performing information collection with excellent universal applicability. The information processing device includes a receiver unit which receives collected information collected by a terminal for information collection from the terminal for information collection, and a terminal administration unit which generates or selects executable software to be executed by the terminal for information collection at the time of information collection after the collection on the basis of the collected information received by the receiver unit, and provides the executable software to the terminal for information collection.

### TECHNICAL FIELD

The present invention relates to a technique which collects information.

### BACKGROUND ART

Patent Documents 1 to 4 describe a technique in which information acquired by a sensor is sent to a server for site visualization. In particular, Patent Document 1 describes a data server which stores measured data measured and collected by a measuring instrument, a processing unit which processes measured data stored in the data server, and a data transmission unit which transmits processed data to a user.

Patent Document 2 describes a technique in which medical information is collected by a client terminal, collected inspection result data is recorded in a server, and necessary information is searched for in the recorded information to perform statistical processing.

Patent Document 3 describes a system which transmits video collected by a device mounted in a worker to a supervisor device, displays video, and various instructions are sent from the supervisor to the worker. Patent Document 4 describes a system in which operation support is performed using information collected by a mobile terminal device provided at a site, positional information, or the like.

### RELATED DOCUMENT

### Patent Document

[Patent Document 1] Japanese Laid-Open Patent Publication No. 2002-8179

[Patent Document 2] Japanese Laid-Open Patent Publication No. 2005-275999

[Patent Document 3] Japanese Patent No. 3217723

[Patent Document 4] Japanese Patent No. 4018455

### SUMMARY OF THE INVENTION

### Technical Problem

However, in the system of the related art, there is no case where a difference in environment is detected so as to make a change to an information collection function, and universal applicability is lacking.

An object of the invention is to provide a technique for solving the above-described problem.

### Solution to Problem

In order to accomplish the above-described object, an information processing device according to the invention includes

a receiver unit which receives collected information collected by a terminal for information collection from the terminal for information collection, and

a terminal administration unit which generates or selects executable software to be executed by the terminal for information collection at the time of information collection which is executed after collecting the collected information on the basis of the collected information received by the receiver unit, and provides the executable software to the terminal for information collection.

In order to accomplish the above-described object, a system according to the invention includes

a terminal for information collection, and an information processing device,

wherein the information processing device includes

a receiver unit which receives collected information collected by the terminal for information collection from the terminal for information collection,

an accumulation unit which accumulates the collected information received by the receiver unit, and

a terminal administration unit which provides necessary executable software to the terminal for information collection on the basis of the received collected information, and

the terminal for information collection includes an information collection unit which executes the executable software provided from the terminal administration unit to collect information.

In order to accomplish the above-described object, a method according to the invention includes

receiving collected information collected by a terminal for information collection from the terminal for information collection; and

generating or selecting executable software to be executed by the terminal for information collection at the time of information collection which is executed after collecting the collected information on the basis of the collected information received in the receiving of the collected information, and providing the executable software to the terminal for information collection.

In order to accomplish the above-described object, a method according to the invention causes a computer to execute

receiving collected information collected by a terminal for information collection from the terminal for information collection; and

generating or selecting executable software to be executed by the terminal for information collection at the time of information collection which is executed after collecting the collected information on the basis of the collected information received in the receiving of the collected information, and providing the executable software to the terminal for information collection.

### Advantageous Effect of the Invention

According to the invention, it is possible to detect a difference in environment so as to make a change to an information collection function, and to perform information collection with excellent universal applicability.

### BRIEF DESCRIPTION OF THE DRAWINGS

FIG. 1 is a diagram illustrating the configuration of a system including an information processing device according to a first embodiment of the invention.

FIG. 2 is a diagram illustrating the schematic configuration of an information processing system according to a second embodiment of the invention.

FIG. 3 is a diagram illustrating the internal configuration of a terminal for information collection which is disposed at a front side of an information processing system according to the second embodiment of the invention.

FIG. 4 is a diagram illustrating the internal configuration of a terminal administration unit and a database in a terminal administration server of an information processing system according to the second embodiment of the invention.

FIG. 5 is a sequence diagram illustrating the operation of an information processing system according to the second embodiment of the invention.

FIG. 6 is a diagram illustrating a table which is used in an information processing system according to the second embodiment of the invention.

FIG. 7 is a diagram illustrating a table which is used in an information processing system according to the second embodiment of the invention.

FIG. 8 is a diagram illustrating a table which is used in an information processing system according to the second embodiment of the invention.

FIG. 9 is a diagram illustrating a table which is used in an information processing system according to the second embodiment of the invention.

FIG. 10 is a diagram specifically illustrating a first example to which an information collection system is applied.

FIG. 11 is a diagram specifically illustrating a second example to which an information collection system is applied.

FIG. 12 is a diagram specifically illustrating a third example to which an information collection system is applied.

FIG. 13 is a diagram specifically illustrating a fourth example to which an information collection system is applied.

FIG. 14 is a diagram specifically illustrating a fifth example to which an information collection system is applied.

### DESCRIPTION OF EMBODIMENTS

Hereinafter, embodiments of the invention will be exemplarily described in detail with reference to the drawings. However, components described in the following embodiments are merely for illustration, are not intended to limit the technical scope of the invention.

### First Embodiment

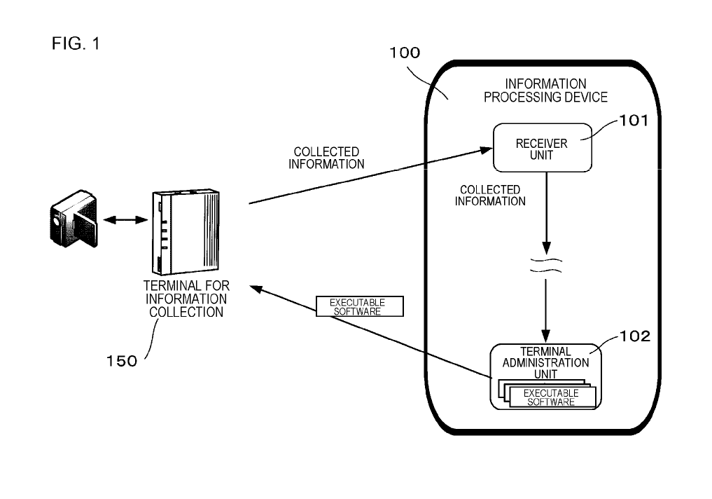

An information processing device 100 according to a first embodiment of the invention will be described with reference to FIG. 1. As illustrated in FIG. 1, the information processing device 100 includes a receiver unit 101 and a terminal administration unit 102. The receiver unit 101 receives collected information collected by a terminal 150 for information collection. The terminal administration unit 102 generates or selects executable software to be executed by the terminal 150 for information collection at the time of information collection on the basis of the collected information received by the receiver unit 101, and provides the executable software to the terminal 150 for information collection.

With the information processing device configured as above, it is possible to detect a difference in environment (at least one of a difference in internal or ambient environment, a change in an information collection target, and the like) of the terminal 150 for information collection so as to make a change to an information collection operation of the terminal 150 for information collection, and to perform information collection with excellent universal applicability.

The information processing device 100 may further include an analysis unit which analyzes the collected information received by the receiver unit 101 so as to generate or select the executable software to be executed by the terminal 150 for information collection at the time of information collection. At least two kinds of sensors may be connectable to the terminal 150 for information collection. In this case, the terminal administration unit 102 may provide executable software according to the kind of sensor connected to the terminal 150 for information collection to the terminal 150 for information collection.

A transmitter unit may be provided to transmit initial software for collecting environmental information of the terminal 150 for information collection to the terminal 150 for information collection before the terminal 150 for information collection collects collected information necessary for generating or selecting executable software. In this case, the terminal administration unit 102 may provide the executable software selected on the basis of the environmental information collected using the initial software to the terminal 150 for information collection. The information processing device 100 is connected to an information collection request terminal (not shown) which transmits an information collection objective, and the terminal administration unit 102 may generate or select executable software on the basis of the information collection objective transmitted from the information collection request terminal.

The environmental information may include information relating to a communication resource inside and around the terminal 150 for information collection. With this information, it is possible to change the executable software of the terminal 150 for information collection, thereby making a change to the information collection operation. The information processing device 100 may further include an executable software storage unit which stores the environmental information in association with the executable software. The information processing device 100 may further include an accumulation unit which accumulates the collected information. In this case, the collected information accumulated in the accumulation unit is analyzed, thereby making the terminal administration method more effective. Information itself accumulated in the accumulation unit may be assigned.

### Second Embodiment

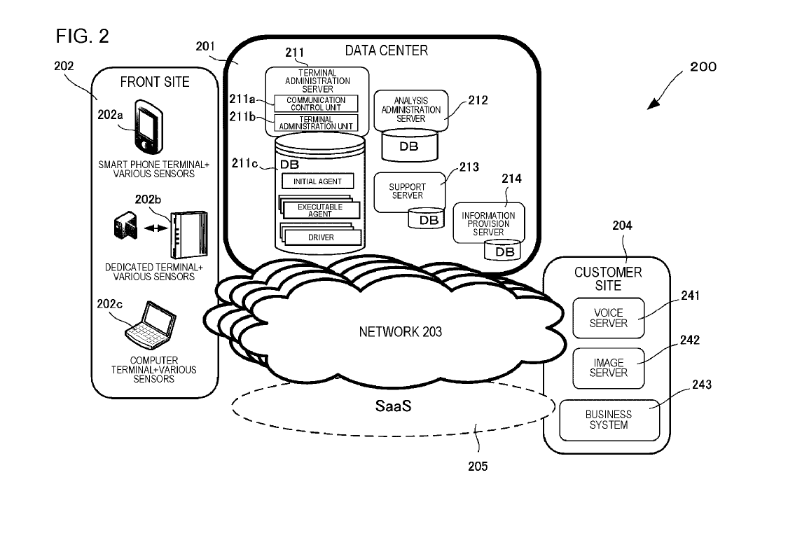

Next, the overall configuration of an information processing system 200 according to a second embodiment of the invention will be described with reference to FIG. 2. The information processing system 200 includes a data center 201 serving as an information processing device, a front site 202, a customer site 204, and a SaaS (Software as a service) 205 which are communicable through a network 203.

Of these, the front site 202 is an instrument which is used at a so-called “site”, and includes, for example, terminals for information collection, such as a smart phone terminal 202a, a dedicated terminal 202b, and a computer terminal 202c. These terminals 202a to 202c for information collection are connected to the data center 201 through the network 203. In this case, as the usable network 203, for example, a wireless communication network, such as WiMAX (Worldwide Interoperability for Microwave Access) or WiFi (Registered Trademark), or a mobile communication network, such as 3G, 3.5G, or 3.9G, is used. The network is not limited to these wireless networks, and sensors may be connected to the network in a wired manner.

The data center 201 is connectable to the customer site 204 or the SaaS 205 through the network 203, such that various kinds of data can be transmitted and received therebetween. The data center 201 has a terminal administration server 211, an analysis administration server 212, a support server 213, and an information provision server 214. These servers respectively have databases.

The database 211c attached to the terminal administration server 211 includes initial software which is called an initial agent, executable software which is called an executable agent, and a driver which drives a sensor used at the front site 202. The terminal administration server 211 includes a communication control unit 211a and a terminal administration unit 211b. The communication control unit 211a receives the collected information collected by the terminal for information collection of the front site 202. The terminal administration unit 211b generates executable software to be executed by the terminal for information collection at the time of information collection on the basis of the collected information received by the communication control unit 211a or selects executable software from the database 211c, and provides the executable software to the terminal for information collection.

The analysis administration server 212 has a function of accumulating information collected by the terminal administration server 211, if necessary, analyzing the information, and returning the analysis result to the terminal administration server 211, and a function of receiving an instruction of an operator of the data center 201 and the customer site 204. The support server 213 has a function of converting voice information or image information from among the information collected by the terminal administration server 211 in an easily analyzable format, or displaying and reproducing the voice information or image information so as to be easily provided to the operator of the data center.

The information provision server 214 has a function of providing the analysis result of the information collected from the front site 202 to the customer site 204 and a function of receiving an instruction from the customer site.

The customer site 204 includes a voice server 241, an image server 242, and a business system 243. The customer site 204 acquires information from the front site 202 through the data center 201, and sends an instruction to the front site 202. When voice is used for information acquisition and instruction, the voice server 241 is used, and when an image is used, the image server 242 is used. When information acquisition, instruction, and analysis provision are performed through character information, such as a mail, or various kinds of sensor information from the front site 202, the business system 243 is used.

The SaaS 205 is, for example, a service, such as map information or weather information, which is usable on the network. The data center 201 accesses the service in accordance with an instruction of the operator or autonomously to acquire information necessary for controlling the front site 202, information necessary for analyzing collected information, or information necessary for reporting to the customer site 204.

A sensor can be connected to or disconnected from the smart phone terminal 202a, the dedicated terminal 202b, the computer terminal 202c, or the like disposed at the front site 202 anytime and anywhere. These terminals for information collection have only minimal standard software in an initial state, and basically execute the initial agent and the executable agent sent from the data center 201 to exhibit the information collection function.

As the smart phone terminal 202a, for example, an Android (Registered Trademark) terminal including a USB interface or a Zigbee module is used. As the dedicated terminal, a mobile voice and image distribution terminal (for example Vl-10 (Registered Trademark)) having a real time communication function, or a helmet (for example, Umet (Registered Trademark)) equipped with a function of detecting and transmitting video, voice, and positional information is used.

With these terminals for information collection, collected information, such as video or voice from various “sites”, such as building and construction works, steel industries, heavy and chemical industries, lifeline facilities, such as electricity, gas supplies, water supplies, railroads, and communication, medical sites, and exhibitions, is distributed to the data center 201 in real time.

With the system configured as above, a lot of works of a worker or the operator of the data center in setting based on the objective of each terminal for information collection or the environment at the front site 202 are not needed, thereby realizing an information collection system with excellent universal applicability. In particular, a user of a terminal at a site can perform information collection by the terminal without considering situations or conditions, and can receive advice from an expert through the terminals for information collection and the data center. In the customer site 204 which is a substantial administrator of the front site 202, it is greatly effective in that site visualization can be realized and information collected at a site can be accumulated and used for future determination. Since the information collection function can be changed in various forms on the basis of the determination on the environment of the terminal for information collection, even when a special system change is not made, it is possible to provide an information collection system with excellent universal applicability which can cope with various information collection objectives. A secondary effect that information accumulated in the data center is sold to other customers can be expected.

### [Configuration of Terminal for Information Collection]

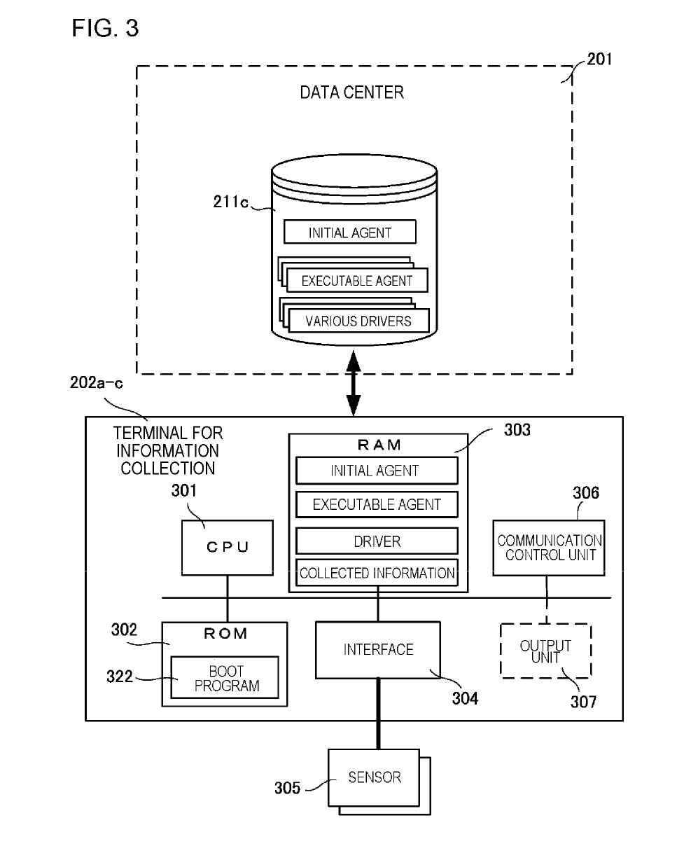

FIG. 3 is a diagram illustrating the internal configuration of a terminal for information collection disposed at the front site 202. The terminal for information collection includes a CPU 301, a RAM 303, a ROM 302, an interface 304, and a communication control unit 306. The CPU 301 is a central processing unit which controls the entire terminal, reads and executes a boot program 322 stored in the ROM 302 at the time of power-on, and informs the data center 201 of power-on using the communication control unit 306.

The RAM 303 has a function of storing an initial agent, an executable agent, and a sensor driver read from the database 211c of the data center 201 and received through the communication control unit 306, and the CPU 301 executes these software. The RAM 303 has a memory area which temporarily stores information collected from the sensor 305 through the interface 304.

The interface 304 has a function of controlling connection to the sensor 305 and storing information detected by the sensor in the RAM 303. As the sensor 305 which is connectable to the interface 304, not only a camera or a microphone, but also various sensors, such as a temperature sensor, a humidity sensor, and a GPS, are used. Connection of the interface 304 and the sensor 305 is not limited to wired communication, such as a USB, and a wireless communication standard, such as Bluetooth, may be used.

The terminal for information collection may include an output unit 307 which outputs an image or voice to a terminal user. As the output unit 307, for example, a display may be provided to display a message “Please wait for a while” during booting by the boot program 322 or to display an instruction to the user of the terminal.

### [Configuration of Terminal Administration Unit]

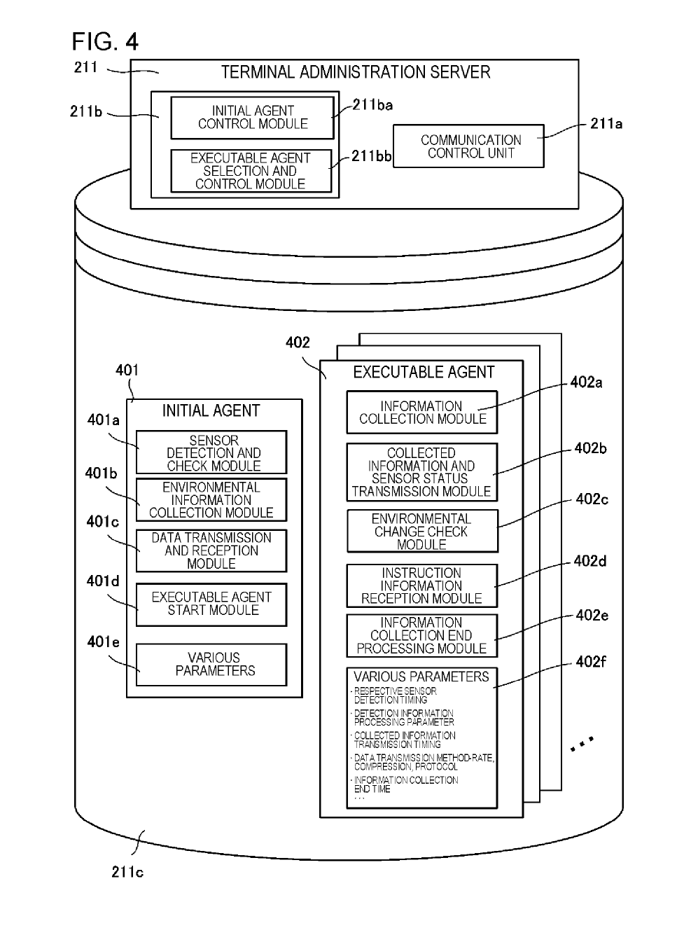

FIG. 4 is a diagram illustrating the internal configuration of the terminal administration unit 211b and the database 211c in the terminal administration server 211. The terminal administration unit 211b includes an initial agent control module 211ba which reads an initial agent 401 from the database 211c to the terminal for information collection through the communication control unit 211a. The terminal administration unit 211b includes an executable agent selection and control module 211bb which reads an executable agent 402 from the database 211c to the terminal for information collection through the communication control unit 211a.

The initial agent 401 includes a sensor detection and check module 401a, an environmental information collection module 401b, data transmission and reception module 401c, an executable agent start module 401d, and various parameters 401e therein. The executable agent 402 includes an information collection module 402a, a collected information and sensor status transmission module 402b, a sensor detection and environmental change check module 402c, an instruction information reception module 402d, and an information collection end processing module 402e. The executable agent 402 includes, as various parameters 402f, information representing respective sensor detection timing, detection information processing parameters, a collected information transmission timing, a data transmission method (speed, compression, and protocol), and an information collection end time.

### [Operation of System]

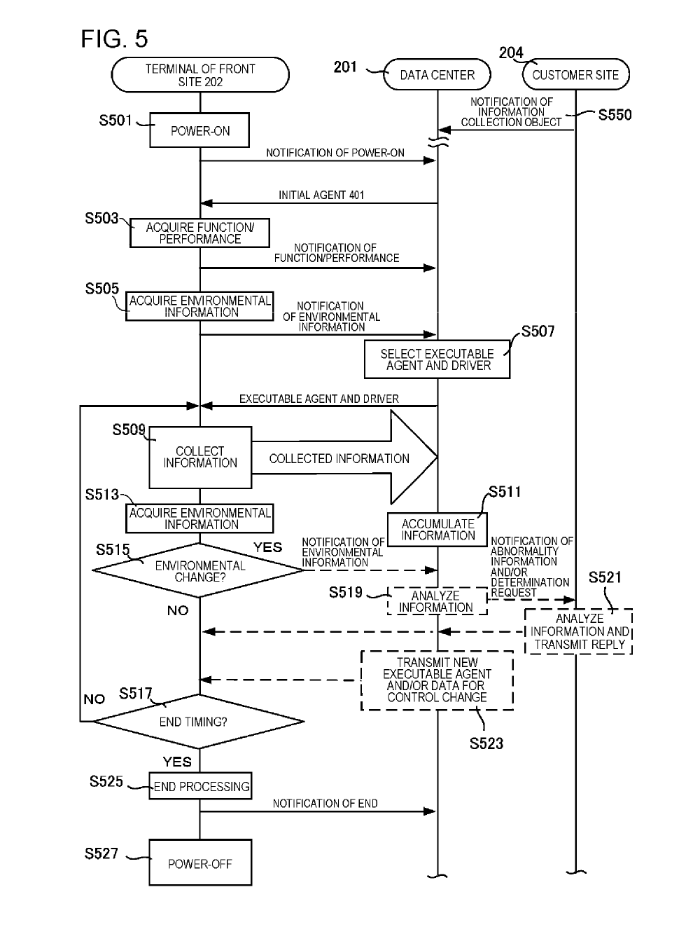

FIG. 5 is a sequence diagram illustrating the operation of this system. In FIG. 5, if a terminal for information collection of the front site 202 is powered on (S501), the boot program 322 of FIG. 3 controls the communication control unit 306 and transmits a power-on notification to the terminal administration server 211 of the data center 201. The terminal administration server 211 transmits the initial agent 401 as a reply to the power-on notification to the terminal for information collection.

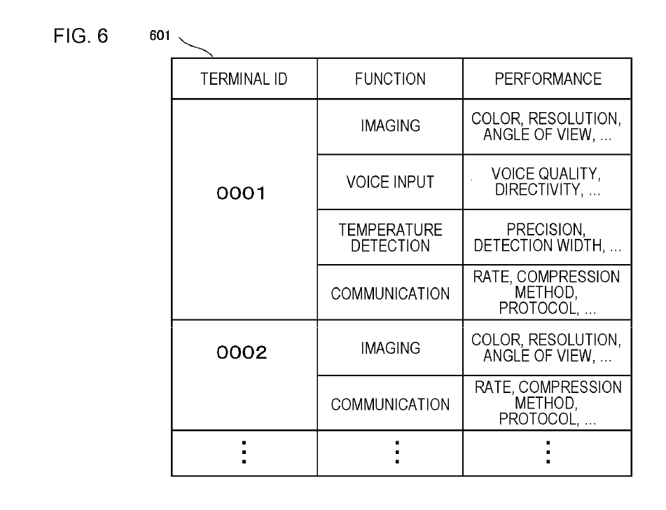

The terminal for information collection receives and executes the initial agent 401. Accordingly, the sensor detection and check module 401a of FIG. 4 detects a sensor attached to the terminal for information collection and acquires the function and performance of the sensor (S503). The function and performance of the attached sensor are notified to the data center 201 by the data transmission and reception module 401c of the initial agent 401, and as illustrated in a table 601 of FIG. 6, are stored along with a terminal ID for identifying the terminal for information collection. In this example, a terminal for information collection of a terminal ID 0001 has a communication function, and a camera, a microphone, and a thermometer are connected thereto. For this reason, an imaging function, a voice input function, a temperature detection function, a communication function, and parameters representing respective performance (in the case of the imaging function, color, resolution, angle of view, and the like) are registered in association with the terminal ID 0001.

Next, in Step S505, the terminal for information collection of the front site 202 drives the sensor using the environmental information collection module 401b of the initial agent 401, acquires environmental information, and notifies the environmental information to the data center 201.

The terminal administration server 211 of the data center 201 generates or selects an executable agent and/or a driver on the basis of the received function and performance, the environmental information notification, and an information collection objective notification (S550) received from the customer site 204 in advance (S507).

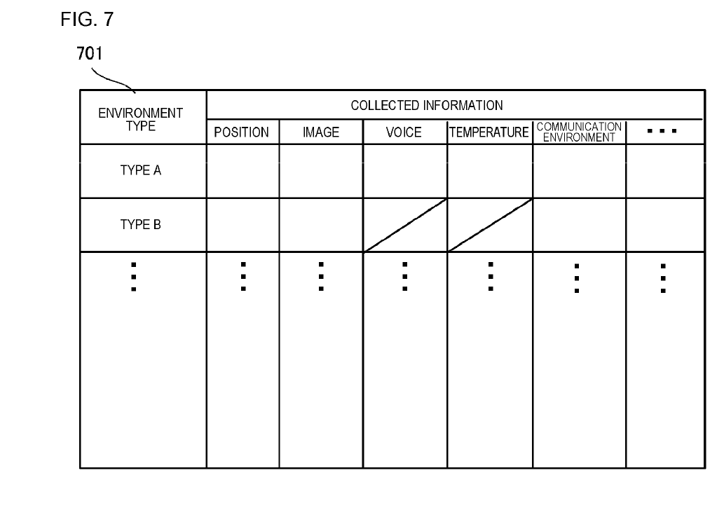

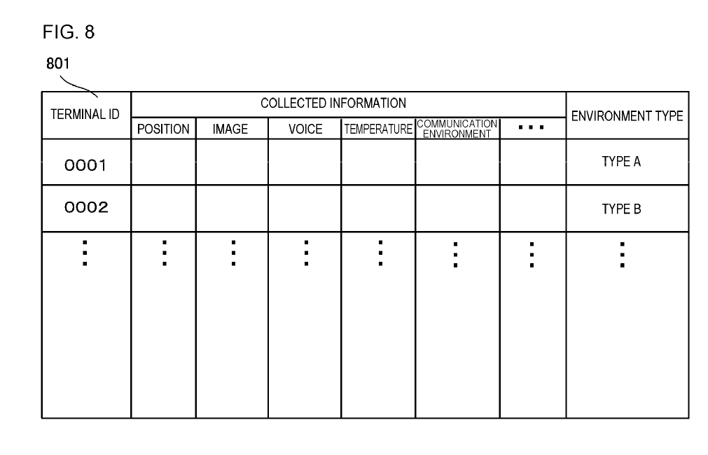

In order to select an executable agent, first, the environment type of the terminal for information collection is determined using tables 701 and 801 of FIGS. 7 and 8. FIG. 7 is a diagram illustrating a table 701 in which the relation between information being collectable by the sensors (a position detected by a GPS, an image captured by a camera, voice acquired by a microphone, temperature measured by a thermometer, signal intensity received by the communication control unit, the amount of transmittable information, and the like) and the environment type is stored. FIG. 8 illustrates a table 801 in which information actually collected by the terminal for information collection is registered. The environment type of each terminal for information collection is determined by comparing actual collected information with a numerical value for environment type determination of FIG. 7 and registered in the table 801.

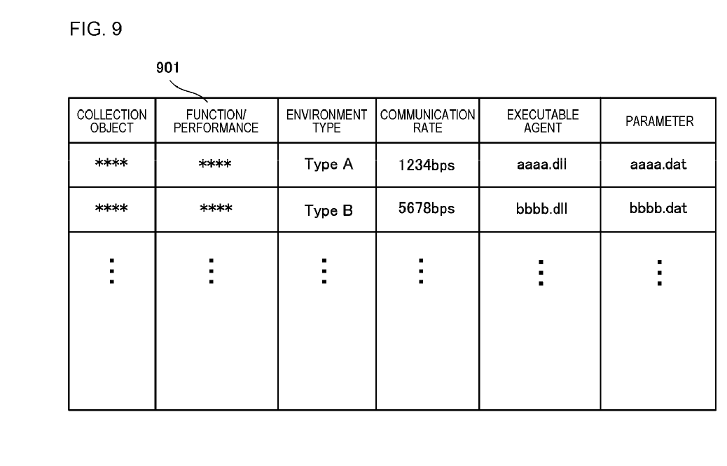

The database of the terminal administration server 211 stores an executable agent selection table 901 illustrated in FIG. 9. This table stores an executable agent and parameters used in the executable agent in association with the information collection object, the function and performance of the terminal for information collection, the environment type, and the communication speed.

An executable agent to be transmitted to the terminal for information collection is determined with reference to the executable agent selection table 901 using information collected using the initial agent, the collection objective notified from the customer site 204, or the like. Although in this table, an example where an existing executable agent is specified, an executable agent generation method and parameters may be registered, and an executable agent to be transmitted to the terminal for information collection may be newly generated.

Next, the terminal administration server 211 transmits the generated or selected executable agent to the terminal for information collection. At this time, if necessary, a driver which operates sensors is also transmitted to the terminal for information collection. The terminal for information collection starts the received executable agent 402 using the executable agent start module 401d of the initial agent 401, and activates the information collection module 402a of the executable agent 402 to perform information collection (S509).

The collected information is transmitted to the data center 201 regularly at a frequency according to the communication environment. The data center 201 accumulates the received information in the database attached to the analysis administration server 212 (S511).

The environmental information of the terminal for information collection is also acquired regularly while collecting objective information (S513), and the sensor detection and environmental change check module 402c checks whether or not there is a change in the environment (S515). For example, when a new sensor is connected or when the environment of the terminal for information collection is changed due to an unexpected accident, this change is transferred to the data center 201.

In the data center 201, the analysis administration server 212 analyzes the accumulated information or the environmental information (S519). As a result of the analysis, some kind of abnormality occurs in the situation of the front site 202, and when it is determined that it is difficult to resolve abnormality only using the data center 201, abnormality information is notified to the customer site 204, and in some cases, expert determination is requested.

In the customer site 204, an expert or the like checks the situation through the voice server 241 or the image server 242 of FIG. 2, and in some cases, has a discusses in the business system 243, such as a network conference system. As a result, if a countermeasure is defined, a reply is transmitted to the front site 202 through the data center 201 or directly (S521). For example, when a new sensor is connected to the terminal for information collection, when a sensor is out of order, or the like, with the determination of the data center 201, a new executable agent according to a new environment is generated or selected, and transmitted to the terminal for information collection (S523). Along with or separately from the transmission of the new executable agent, data for changing control may be transmitted. The terminal for information collection receives an instruction from the data center 201 or the customer site 204 using the instruction information reception module 402d of the executable agent 402. The data center 201 may cooperate with the customer site 204 automatically without using human hands. For example, with the result of BN (Bayesian Network) deduction, the actions of S521 and S523 may be determined.

The information collection operation is repeated, and if the end timing is reached, the process progresses from Step S517 to S525, and the information collection end processing module 402e of the executable agent 402 performs end processing. For example, the information collection end processing module 402e or various parameters 402f set in advance such that the end processing is performed when the end time is reached or when information collection of a prescribed amount or item ends . After the end processing, power is off (S527).

### First Application Example

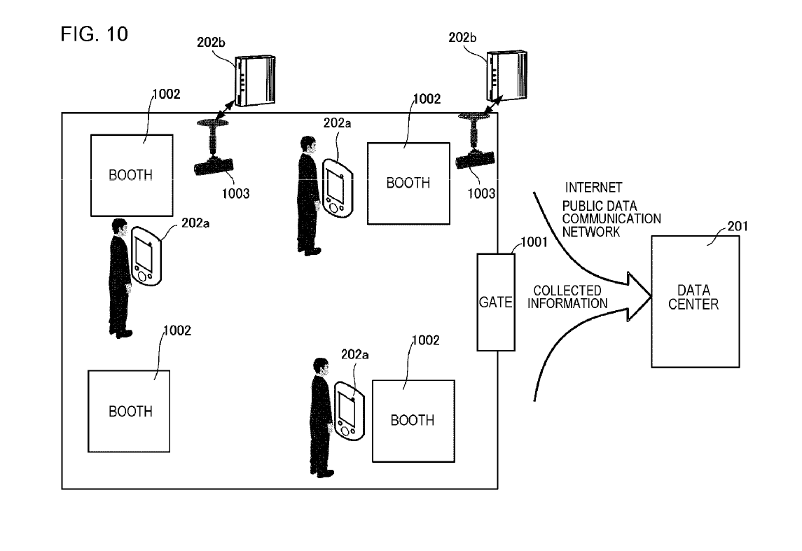

FIG. 10 is a diagram specifically illustrating a first application example where the above-described information processing system 200 is applied to an exhibition system. In an exhibition, a plurality of smart phone terminals 202a corresponding to a prescribed number of visitors are prepared. A microphone and a camera are connected to the smart phone terminal 202a, and connected sensors (camera, microphone, and the like) and communication line quality, and the like are checked using an initial agent in advance.

The smart phone terminal 202a is handed to each visitor who enters from a gate 1001. At this time, individual information, such as a photograph of the face of a visitor, may be registered in the data center 201 through the smart phone terminal 202a.

A dedicated terminal 202b is connected to a camera 1003 which is installed in an exhibition hall. The dedicated terminal 202b executes an executable agent downloaded from the data center 201 to control the camera 1003, and collects information relating to the positions or the number of booths 1002, the motions of visitors, and the like.

With this system, information relating to how many visitors visit a booth, how sequence the visitors are more likely to go around the booths, and what a visitor does in a booth can be acquired and accumulated in the data center 201. At this time, it is not necessary to perform special settings to the smart phone terminal 202a or the dedicated terminal 202b, and it is possible to very simply perform information collection.

### Second Application Example

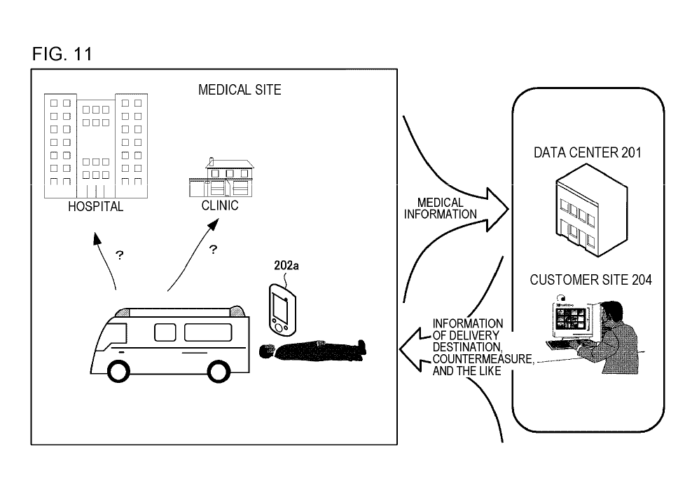

FIG. 11 is a diagram specifically illustrating a second application example where the above-described information processing system 200 is applied to a medical system. For example, in the medical system of this drawing, an ambulance transporting staff holds the smart phone terminal 202a. The smart phone terminal 202a is equipped with a camera, and a sensor for measuring a vital, such as a sphygmomanometer or a clinical thermometer, is connected thereto. A photograph or individual information of a patient to be transported is input using the smart phone terminal 202a and sent to the data center 201. The body temperature, blood pressure, and the like are measured using various sensors, and sent from the smart phone terminal 202a to the data center 201. Information accumulated in the data center 201 is presented to an expert (in this case, normally, an experienced physician) through the customer site 204, and a countermeasure is inquired. The expert informs the transporting staff of which hospital the patient should be transported or what kind of countermeasure should be taken during the transportation with reference to various databases. Countermeasure information is accumulated in the data center 201 and will be analyzed.

The collected medical information is accumulated in association with the countermeasure information from the expert, analysis is performed. Accordingly, the data center 201 can determine a countermeasure against information from the patient spontaneously before getting the expert's opinion.

If the invention is applied to this system, it is possible to construct a medical system which attains ease of introduction and ease of use.

### Third Application Example

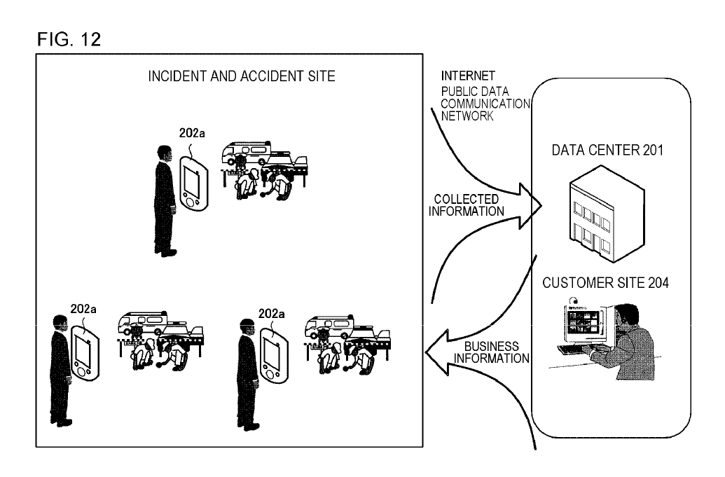

FIG. 12 is a diagram specifically illustrating a third application example where the above-described information processing system 200 is applied to a security system. For example, in the security system of this drawing, a site staff, such as a police officer or a detective, holds the smart phone terminal 202a. Information relating to an incident or accident place, time, weather, fingerprint images, things left behind, site video, and the like is collected smart phone terminal 202a and sent to the data center 201. In the data center 201, the collected information is analyzed to search a criminal, to estimate the escape route of the criminal, or to draw up a future security plan. At this time, video and the like may be sent to the customer site 204 to get the expert's opinion or to perform fingerprint verification. The expert of the customer site 204 may send an instruction directly to the site on the basis of the collected information.

In the security, such as the police, since high priority is placed on the site activity, very effective investigation and on-site verification can be realized by visualizing the site and accumulating and analyzing information.

### Fourth Application Example

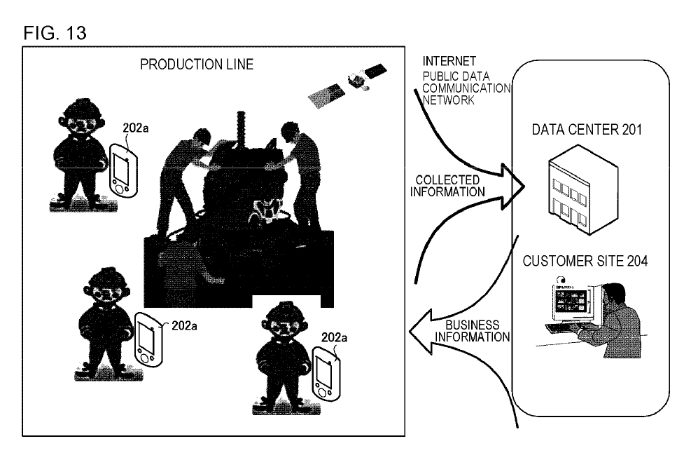

FIG. 13 is a diagram specifically illustrating a fourth application example where the above-described information processing system 200 is applied to a production line. For example, in the production line of the drawing, a site worker holds the smart phone terminal 202a. Various sensors, such as a camera and a microphone, are connected to the smart phone terminal 202a to collect information relating to the production line. Information collection may be performed from a speed detector of a manufacturing line of a factory, a sensor which measures the amount of oil using near field communication, such as Bluetooth (Registered Trademark).

When the production line has failure, information relating to failure place, time, site video, and the like is collected by the smart phone terminal 202a and sent to the data center 201. In the data center 201, the collected information is analyzed to specify the cause of failure, or to draw up a further countermeasure. At this time, video and the like may be sent to the customer site 204 to get the expert's opinion. The expert of the customer site 204 may send an instruction directly to the site on the basis of the collected information. For example, the data center 201 may search for information related to the production line in the database, and may provide information when manufacturing, basic condition materials of production, or the like to the customer site 204.

### Fifth Application Example

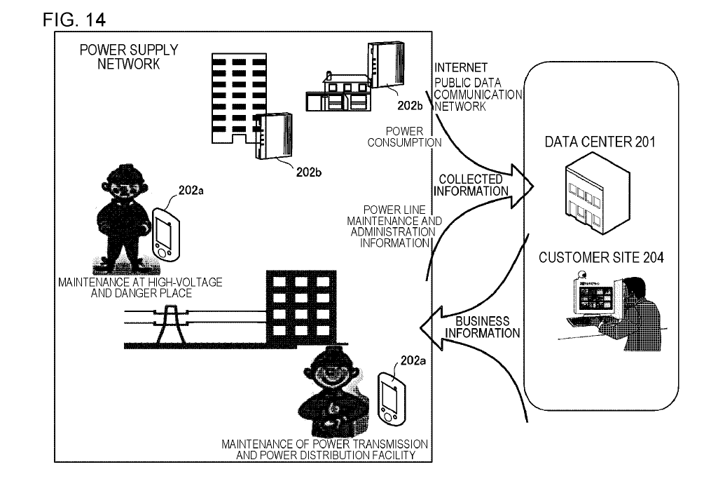

FIG. 14 is a diagram specifically illustrating a fifth application example where the above-described information processing system 200 is applied to electric power management. For example, in the electric power supply network of this drawing, a site worker holds the smart phone terminal 202a, and a dedicated terminal 202b is installed at home or an office. A camera or various sensors are connected to the smart phone terminal 202a to collect information relating to the electric power facility. At home or the office, the dedicated terminal 202b collects information from a voltage detector, a sensor for measuring the amount of power consumption, and the like using near field communication, such as Bluetooth (Registered Trademark).

When the electric power facility has failure, information relating to failure place, time, site video, and the like is collected by the smart phone terminal 202a and sent to the data center 201. In the data center 201, the collected information is analyzed to specify the cause of failure, or to draw up a future countermeasure. At this time, video and the like may be sent to the customer site 204 to get the expert's opinion. The expert of the customer site 204 may send an instruction directly to the site on the basis of the collected information. Accordingly, it is possible to prevent an accident, to minimize damage at the time of the occurrence of an accident, and to minimize social and economical damage. In the customer site 204, customer management, power consumption notification, power transmission facility maintenance and management, disaster response, worker safety management, and the like may be performed.

The amount of power consumption may be collected in real time from the home or office, analyzed, and accumulated in the data center 201 to determine the tendency or to control the amount of power supply.

### Other Application Examples

At a distribution site, information relating to the shop position, the number of guests, and the amount of stock maybe collected, accumulated, and analyzed. A terminal for information collection may be disposed at a site, such as a bank or a stock company, financial information may be accumulated, and financial management may be performed. For example, a terminal for information collection may have a function of receiving information from a pacemaker, and may be used to manage the health state of an old person or the like necessary for home care.

### Effects of Embodiments

As described above, the information collection system of this embodiment enables real-time information communication between a site worker, an office worker, and an expert, thereby improving productivity or service quality. Even when there is trouble at a remote location, a site worker may collect information using a terminal for information collection and may share real-time information at the site with an operator, such as an expert. The operator identifies rapidly relevant information using a network service application, makes specialized determination, and helps the site worker. Therefore, it is possible to improve productivity of the site worker and to achieve efficient support operation.

### Other Embodiments

Although the embodiments of the invention have been described in detail, a system or device in which different features of the embodiments are combined in any forms still falls within the scope of the invention.

The invention may be applied to a system which has a plurality of equipments or maybe applied to a single device. The invention may be applied to when an information processing program for realizing the functions of the embodiments is supplied to the system or the device directly or remotely. Therefore, a program which is installed on a computer so as to the functions of the invention using the computer, a medium which stores the program, and a WWW server through which the program is downloaded still fall within the scope of the invention.

### Other Expressions of Embodiments

Some or all of the embodiments may be described as in the following supplementary notes. However, the invention is not limited to the following.

### (Supplementary Note 1)

An information processing device including:

a receiver unit which receives collected information collected by a terminal for information collection from the terminal for information collection, and

a terminal administration unit which generates or selects executable software to be executed by the terminal for information collection at the time of information collection on the basis of the collected information received by the receiver unit, and provides the executable software to the terminal for information collection.

### (Supplementary Note 2)

The information processing device described in Supplementary Note 1, further including:

an analysis unit which analyzes the collected information received by the receiver unit so as to generate or select the executable software to be executed by the terminal for information collection at the time of information collection.

### (Supplementary Note 3)

The information processing device described in Supplementary Note 1 or 2, wherein at least two or more kinds of sensors are connectable to the terminal for information collection, and the terminal administration unit provides the executable software according to the kind of sensor connected to the terminal for information collection to the terminal for information collection.

### (Supplementary Note 4)

The information processing device described in any one of Supplementary Notes 1 to 3, further including:

a transmitter unit which, before the terminal for information collection collects the collected information necessary for generating or selecting the executable software, transmits initial software which is used to collect environmental information representing the operation environment of the terminal for information collection by the terminal for information collection to the terminal for information collection.

### (Supplementary Note 5)

The information processing device described in Supplementary 4, wherein the terminal administration unit generates or selects the executable software on the basis of environmental information collected by using the initial software.

### (Supplementary Note 6)

The information processing device described in Supplementary Note 4 or 5, wherein the environmental information includes information relating to a communication resource inside and around the terminal for information collection.

### (Supplementary Note 7)

The information processing device described in any one of Supplementary Notes 4 to 6, an executable software storage unit which stores the environmental information in association with the executable software.

### (Supplementary Note 8)

The information processing device described in any one of Supplementary Notes 1 to 7,

wherein the information processing device is connected to an information collection request terminal which transmits an information collection objective, and

the terminal administration unit generates or selects the executable software on the basis of the information collection objective transmitted from the information collection request terminal.

### (Supplementary Note 9)

The information processing device described in any one of Supplementary Notes 1 to 8, further including:

an accumulation unit which accumulates the collected information.

### (Supplementary Note 10)

An information processing system including:

a terminal for information collection; and

an information processing device,

wherein the information processing device includes

a receiver unit which receives collected information collected by the terminal for information collection from the terminal for information collection, and

an accumulation unit which accumulates the collected information received by the receiver unit, and

a terminal administration unit which provides necessary executable software to the terminal for information collection on the basis of the received collected information, and

the terminal for information collection includes

an information collection unit which executes the executable software provided from the terminal administration unit to collect information.

### (Supplementary Note 11)

An information processing method including:

receiving collected information collected by a terminal for information collection from the terminal for information collection; and

generating or selecting executable software to be executed by the terminal for information collection at the time of information collection on the basis of the collected information received in the receiving of the collected information, and providing the executable software to the terminal for information collection.

### (Supplementary Note 12)

An information processing program which causes a computer to execute:

receiving collected information collected by a terminal for information collection from the terminal for information collection; and

generating or selecting executable software to be executed by the terminal for information collection at the time of information collection on the basis of the collected information received in the receiving of the collected information, and providing the executable software to the terminal for information collection.

This application claims priority based on Japanese Patent Application No. 2010-064005, filed Mar. 19, 2010, the entire disclosure of which is incorporated herein.

1. An information processing device comprising:
a receiver unit which receives collected information collected by a terminal for information collection from the terminal for information collection; and
a terminal administration unit which generates or selects executable software to be executed by the terminal for information collection at the time of information collection which is executed after collecting the collected information on the basis of the collected information received by the receiver unit, and provides the executable software to the terminal for information collection.

2. The information processing device according to claim 1, further comprising:
an analysis unit which analyzes the collected information received by the receiver unit so as to generate or select the executable software.

3. The information processing device according to claim 1,
wherein at least two or more kinds of sensors are connectable to the terminal for information collection, and the terminal administration unit provides the executable software according to the kind of sensor connected to the terminal for information collection to the terminal for information collection.

4. The information processing device according to claim 1, further comprising:
a transmitter unit which, before the terminal for information collection collects collected information necessary for generating or selecting the executable software, transmits initial software which is used to collect environmental information representing the operation environment of the terminal for information collection by the terminal for information collection to the terminal for information collection.

5. The information processing device according to claim 4,
wherein the terminal administration unit generates or selects the executable software on the basis of environmental information collected by using the initial software.

6. The information processing device according to claim 4,
wherein the environmental information includes information relating to a communication resource inside and around the terminal for information collection.

7. The information processing device according to claim 4, further comprising:
an executable software storage unit which stores the environmental information in association with the executable software.

8. The information processing device according to claim 1,
wherein the information processing device is connected to an information collection request terminal which transmits an information collection objective, and
the terminal administration unit generates or selects the executable software on the basis of the information collection objective transmitted from the information collection request terminal.

9. The information processing device according to claim 1, further comprising:
an accumulation unit which accumulates the collected information.

10. An information processing system comprising:
a terminal for information collection; and
an information processing device,
wherein the information processing device includes
a receiver unit which receives collected information collected by the terminal for information collection from the terminal for information collection,
an accumulation unit which accumulates the collected information received by the receiver unit, and
a terminal administration unit which provides necessary executable software to the terminal for information collection on the basis of the received collected information, and
the terminal for information collection includes
an information collection unit which executes the executable software provided from the terminal administration unit to collect information.

11. An information processing method comprising:
receiving collected information collected by a terminal for information collection from the terminal for information collection; and
generating or selecting executable software to be executed by the terminal for information collection at the time of information collection which is executed after collecting the collected information on the basis of the collected information received in the receiving of the collected information, and providing the executable software to the terminal for information collection.

12. An information storage medium storing an information processing program which causes a computer to execute:
receiving collected information collected by a terminal for information collection from the terminal for information collection; and
generating or selecting executable software to be executed by the terminal for information collection at the time of information collection which is executed after collecting the collected information on the basis of the collected information received in the receiving of the collected information, and providing the executable software to the terminal for information collection.
